(19) United States
(12) Patent Application Publication
(10) Pub. No.: US 2008/0152870 A1
(43) Pub. Date: Jun. 26, 2008

(54) TRANSPARENT ELECTRICALLY-CONDUCTIVE HARD-COATED SUBSTRATE AND METHOD FOR PRODUCING THE SAME

(76) Inventors: Katsunori Takada, Ibaraki-shi (JP); Toshitaka Nakamura, Oceanside, CA (US); Noriyuki Juni, Ibaraski-shi (JP); Amane Mochizuki, San Diego, CA (US); Hiroaki Miyagawa, Oceanside, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/615,831

(22) Filed: Dec. 22, 2006

(51) Int. Cl. B32B 9/04; B05D 1/36; B32B 3/10

(52) U.S. Cl. 428/174; 427/407.1; 428/220; 428/411.1

(57) ABSTRACT

A transparent electrically-conductive hard-coated substrate of the invention comprises a transparent base material; a deposited carbon nanotubes layer formed on the transparent base material; and a cured resin layer formed on the deposited carbon nanotubes layer, wherein the deposited carbon nanotubes layer has a thickness of 10 nm or less, the total thickness of the deposited carbon nanotubes layer and the cured resin layer is 1.5 μm or more, and part of the deposited carbon nanotubes layer is diffused into the cured resin layer so that carbon nanotubes are present in the cured resin layer. The transparent electrically-conductive hard-coated substrate possesses high transparency and hard coating properties and also has electrical conductivity.

### BACKGROUND OF THE INVENTION

1. Field of the Invention

The invention relates to a transparent electrically-conductive hard-coated substrate using carbon nanotubes on one side of a transparent base material and further using a cured resin layer and also relates to a method for producing the same. For example, the transparent electrically-conductive hard-coated substrate of the invention may be used for polarizing plates and the like. The transparent electrically-conductive hard-coated substrate of the invention and polarizing plates therewith are also suitable for use in image displays, particularly in cathode-ray tubes (CRTs), liquid crystal displays (LCDs), plasma display panels (PDPs), electroluminescent displays (ELDs), and the like.

2. Description of the Related Art

Technological innovation of LCD (one of various types of image displays) for wide viewing angle, high definition, rapid response, color reproducibility, and the like has been accompanied by changes of LCD applications from notebook computers and monitors to televisions. An established basic LCD structure includes two pieces of flat glass plates each with a transparent electrode, a constant gap provided with spacers between the glass plates, a liquid crystal material injected into the gap and sealed therein, and polarizing plates which are attached to the front and rear sides of the glass plates after the sealing. Although TN mode has traditionally been the main stream of liquid crystal modes, upsizing and wide viewing angle technology have progressed so that VA and IPS modes have become the main stream. These high performance liquid crystal modes are very sensitive to static electricity, and there has been a problem in which static electricity can cause a disturbance in liquid crystal driving, white spots, or circuit destruction. Particularly in IPS mode, ITO treatment of glass substrates, which is performed to avoid the problem of static electricity, is very expensive and thus becomes a factor of cost increase. At present, therefore, investigations have been made to impart electrical conductivity to polarizing plates themselves.

In general, either a dry process or a wet process is used when a transparent base material is subjected to electrically conducting treatment to form a transparent electrically-conductive hard-coated substrate. In the dry process, an electrically-conductive layer is formed by PVD or CVD using an electrically-conductive metal oxide such as indium tin oxide (ITO), antimony tin oxide (ATO), and aluminum-doped zinc oxide (FTO). In the wet process, an electrically-conductive powder of a mixture of the above oxides or the like and a binder are used to form an electrically-conductive coating composition, and the composition is applied to a base material to form an electrically-conductive layer. By the dry process, electrically-conductive substrates with both good transparency and good electrical conductivity can be obtained. The dry process, however, requires a complicated apparatus having a pressure-reducing system and thus has low productivity. The wet process uses a relatively simple apparatus and has high productivity and can be easily applied to a continuous or large substrate. The electrically-conductive powder used in the wet process is very fine so as not to interfere with the transparency of the resulting transparent electrically-conductive hard-coated substrate and thus has a primary average particle size of 0.5 μm or less. In order to keep transparency, the electrically-conductive powder to be used has a primary average particle size of at most half of the shortest visible light wavelength (0.2 μm) such that it does not absorb visible light and scatters visible light in a controlled manner.

Known electrically-conductive materials include organic polymers and plastics. The development of these materials was started from the late 1970's. As a result of the development, there have been obtained electrically-conductive materials mainly composed of polymers such as polyaniline, polythiophene, polypyrrole, and polyacetylene. These electrically-conductive organic polymers are used in the wet process. The electrically-conductive organic polymers can form an electrically-conductive single layer with sufficient electrically conducting performance but do not have hard coating properties. Hard coating properties can be established by coating, with a hard coat layer, the electrically-conductive layer formed with the electrically-conductive organic polymer. In such a method, however, electrical conductivity cannot be ensured, and there is a trade-off between electrical conductivity and hard coating properties.

In order to produce an electrically-conductive hard-coated substrate having both electrical conductivity and hard coating properties, there is proposed a method that includes applying an ATO-containing ink onto a transparent base material and then forming thereon a coating of an antiglare layer containing gold-nickel-coated resin beads (see Japanese Patent No. 3507719). This method can achieve electrical conductivity and hard coating properties but has a problem in which the difference in refractive index between the gold-nickel-coated resin beads and the hard coat resin causes a haze and a reduction in transparency.

There is also disclosed a method for preparing a transparent electrically-conductive hard-coated substrate, which includes impregnating, with a binder resin, carbon nanotubes that form a three-dimensional network structure on a transparent base material (see Japanese Patent No. 3665969). In order to achieve electrical conductivity on the surface side, this method includes forming a 1 μm-thick coating of a carbon nanotubes dispersion to form a three-dimensional network of carbon nanotubes and forming a coating of the binder resin in the three-dimensional network. In this method, however, the binder resin coating is so thin that it is difficult to achieve hard coating properties. The publication also discloses a method that includes forming a 1 μm-thick coating of a carbon nanotubes dispersion, forming a 25 μm resin coating thereon, and separating the coatings from the base material to produce an independent film. In this method, electrical conductivity can be achieved on the separated side surface, but electrical conductivity cannot be achieved on the surface of the coating film resin side. Therefore, this method cannot achieve electrical conductivity with respect to any coating film formed on a base material.

### SUMMARY OF THE INVENTION

It is an object of the invention to provide a transparent electrically-conductive hard-coated substrate that possesses high transparency and hard coating properties and also has electrical conductivity and to provide a method for producing such a substrate.

It is another object of the invention to provide a polarizing plate using the transparent electrically-conductive hard-coated substrate and an image display comprising the transparent electrically-conductive hard-coated substrate or the polarizing plate.

As a result of active investigations for solving the above problems, the inventors have found the transparent electrically-conductive hard-coated substrate and method of manufacture thereof as described below to complete the invention.

That is, the invention is related to a transparent electrically-conductive hard-coated substrate, comprising:

a transparent base material;

a deposited carbon nanotubes layer formed on the transparent base material; and

a cured resin layer formed on the deposited carbon nanotubes layer, wherein

the deposited carbon nanotubes layer has a thickness of 10 nm or less,

the total thickness of the deposited carbon nanotubes layer and the cured resin layer is 1.5 μm or more, and

part of the deposited carbon nanotubes layer is diffused into the cured resin layer so that carbon nanotubes are present in the cured resin layer.

In the transparent electrically-conductive hard-coated substrate, the carbon nanotubes are preferably a single-walled carbon nanotubes.

In the transparent electrically-conductive hard-coated substrate, a cured resin layer side of the transparent electrically-conductive hard-coated substrate preferably has a surface resistance of 1.0×10¹⁰Ω/□ or less.

In the transparent electrically-conductive hard-coated substrate, the total thickness of the deposited carbon nanotubes layer and the cured resin layer is preferably from 1.5 μm to 30 μm.

In the transparent electrically-conductive hard-coated substrate, an outer side of the cured resin layer having an irregular fine surface structure may be used.

The transparent electrically-conductive hard-coated substrate further may comprise at least one anti-reflection layer formed on the cured resin layer.

The invention also related to a polarizing plate, comprising:

a polarizer; and

the above transparent electrically-conductive hard-coated substrate, wherein the transparent base material side of the substrate is laminated with at least one side of the polarizer.

The invention also related to an image display, comprising the above transparent electrically-conductive hard-coated substrate or the above polarizing plate.

The invention further related to a method for producing a transparent electrically-conductive hard-coated substrate that comprises a transparent base material, a deposited carbon nanotubes layer on the transparent base material and a cured resin layer on the deposited carbon nanotubes layer, comprising the steps of:

applying, to a transparent base material, a carbon nanotubes dispersion containing carbon nanotubes and a solvent and drying it to form a deposited carbon nanotubes layer with a thickness of 10 nm or less;

applying, to the deposited carbon nanotubes layer, a solution of a material for forming a cured resin layer in a solvent, removing the solvent by drying, then curing the material to form a cured resin layer such that the deposited carbon nanotubes layer and the cured resin layer provide a total thickness of 1.5 μm or more, and

allowing carbon nanotubes to diffuse from part of the deposited carbon nanotubes layer to the material for forming the cured resin layer before the curing for the cured resin layer is completed.

In the method, the deposited carbon nanotubes layer preferably has a surface resistance of 1.0×10⁹Ω/□ or less.

In the method, the deposited carbon nanotubes layer preferably has an open area ratio of 50% or more.

In the method, the solvent used in the solution of the material for forming the cured resin layer preferably has a boiling point of 50° C. to 160° C.

In the method, the carbon nanotubes are preferably a single-walled carbon nanotubes.

In the method, a cured resin layer side of the obtained transparent electrically-conductive hard-coated substrate preferably has a surface resistance of 1.0×10¹⁰Ω/□ or less.

In the method, the total thickness of the deposited carbon nanotubes layer and the cured resin layer is preferably from 1.5 μm to 30 μm.

In the transparent electrically-conductive hard-coated substrate of the invention, a deposited carbon nanotubes layer with a thickness of 10 nm or less is formed on a transparent base material so that a two-dimensional network of carbon nanotubes is formed in the in-plane direction to establish in-plane conduction. The deposited carbon nanotubes layer has a thickness of 10 nm or less and thus can retain high transparency. In addition, a cured resin layer that is formed on the deposited carbon nanotubes layer such that the total of the thickness of the resin layer and the thickness of the deposited carbon nanotubes layer is 1.5 μm or more can ensure hard coating properties.

In addition, part of the deposited carbon nanotubes layer is diffused in the cured resin layer. The content of the carbon nanotubes in the cured resin layer, which are derived from the deposited layer, is so very low that they do not affect the transparency or the hard coating properties. Because the carbon nanotubes are diffused from the deposited layer into the cured resin layer, it can be thinkable that the carbon nanotubes can be diffused such that the longitudinal direction of the carbon nanotubes becomes parallel to the thickness direction of the cured resin layer in the process of forming the cured resin layer and that conduction can be established also in the thickness direction of the transparent electrically-conductive hard-coated substrate. Thus, the transparent electrically-conductive hard-coated substrate of the invention can ensure conduction both in the in-plane direction and in the thickness direction and therefore has good electrical conductivity.

### BRIEF DESCRIPTION OF DRAWINGS

FIG. 1 is a cross-sectional view showing an example of the transparent electrically-conductive hard-coated substrate of the invention;

FIG. 2 is a cross-sectional view showing an example of the polarizing plate using the transparent electrically-conductive hard-coated substrate of the invention; and

FIG. 3 is an SEM image used for the calculation of the open area ratio of a deposited carbon nanotubes layer for Example 2.

### DETAILED DESCRIPTION OF THE PREFERRED EXAMPLES

Embodiments of the invention with respect to the transparent electrically-conductive hard-coated substrate and the polarizing plate therewith are described in detail below.

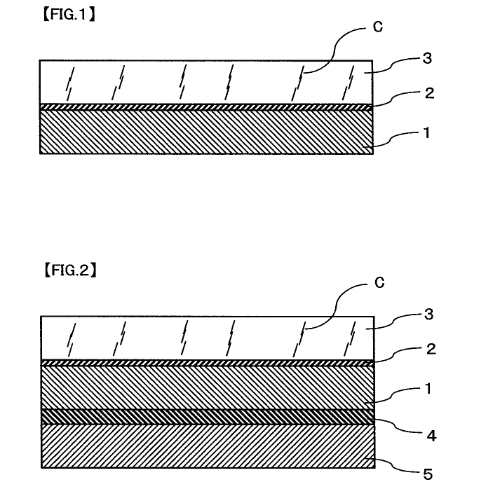

Referring to FIG. 1, a transparent electrically-conductive hard-coated substrate according to the invention includes a transparent base material 1 and a deposited carbon nanotubes layer 2 and a cured resin layer 3 containing a small amount of carbon nanotubes C, which are provided on one side of the transparent base material 1. Referring to FIG. 2, the transparent base material 1 side of the transparent electrically-conductive hard-coated substrate may be bonded to a polarizer 4 and used as a transparent protective film to form a polarizing plate. The other side of the polarizer 4 may be bonded to another transparent protective film 5.

The transparent base material may be any material having good visible-light transmittance (preferably a light transmittance of 90% or more) and good transparency (preferably a haze value of 1% or less). Examples of such materials include polyester resins such as polyethylene terephthalate and polyethylene naphthalate; cellulose resins such as diacetyl cellulose and triacetyl cellulose; acrylic resins such as poly(methyl methacrylate); styrene-based resins such as polystyrene, acrylonitrile-styrene copolymers, styrene resins, acrylonitrile-styrene resins, acrylonitrile-butadiene-styrene resins, acrylonitrile-ethylene-styrene resins, styrene-maleimide copolymers, and styrene-maleic anhydride copolymers; and polycarbonate resins. Examples of the resin for forming the transparent base material such as a polymer film also include polyolefin resins such as cycloolefin resins, norbornene resins, polyethylene, polypropylene, and ethylene-propylene copolymers, vinyl chloride resins, amide resins such as nylon and aromatic polyamide, imide resins such as aromatic polyimide and polyimide-amide, sulfone resins, polyethersulfone resins, polyetherether ketone resins, polyphenylene sulfide resins, vinyl alcohol resins, vinylidene chloride resins, vinyl butyral resins, arylate resins, polyoxymethylene resins, epoxy resins, and any blends thereof. Besides the above, the transparent base material may be a glass substrate or the like. In particular, the transparent base material to be used preferably has low optical birefringence.

Examples thereof also include the polymer film disclosed in Japanese Patent Application Laid-Open (JP-A) No. 2001-343529 (WO01/37007), such as a resin composition including: (A) a thermoplastic resin with a side chain having a substituted and/or unsubstituted imide group; and (B) a thermoplastic resin with a side chain having a substituted and/or unsubstituted phenyl and nitrile groups. Examples thereof include films of a resin composition containing an isobutylene-N-methylmaleimide alternating copolymer and an acrylonitrile-styrene copolymer. The film may be a product formed by mixing and extruding the resin composition.

When the transparent electrically-conductive hard-coated substrate is used as a transparent protective film for a polarizer, the transparent base material is preferably as colorless as possible. Thus, a base material film having a retardation of −90 nm to +75 nm in the film thickness direction is preferably used, wherein the retardation in the film thickness direction (the thickness direction retardation) is represented by Rth=[(nx+ny)/2−nz]d, wherein nx and ny each represent a principal refractive index in the plane of the film, nz represents a refractive index in the film thickness direction, and d represents the thickness of the film. The thickness direction retardation (Rth) is more preferably from −80 nm to +60 nm, particularly preferably from −70 nm to +45 nm.

When the transparent electrically-conductive hard-coated substrate of the invention is used as a transparent protective film for a polarizing plate, the transparent base material is preferably made of triacetyl cellulose, polycarbonate, an acrylic polymer, or polyolefin having a cyclic or norbornene structure.

Alternatively, the transparent base material may be a polarizer itself as described below. Such a structure does not require any transparent protective layer of triacetyl cellulose or the like on one side of the polarizer and can simplify the structure of the polarizing plate so that the number of manufacturing processes can be reduced and that the production efficiency can be increased. In addition, the polarizing plate can be made thinner. When the transparent base material is a polarizer, the cured resin layer of the transparent electrically-conductive hard-coated substrate can serve as a usual transparent protective layer. The transparent electrically-conductive hard-coated substrate can also function as a cover plate to be attached to the surface of a liquid crystal cell.

While the thickness of the transparent base material may be determined as needed, it is preferably from about 10 to about 500 μm, particularly preferably from 20 to 300 μm, more preferably from 30 to 200 μm, generally in terms of strength, workability such as handleability, thin layer properties, or the like. The refractive index of the transparent base material is generally, but not limited to, from about 1.30 to about 1.80, preferably from 1.40 to 1.70.

The deposited carbon nanotubes layer formed on the transparent base material can percolate in the in-plane direction. Such a deposited carbon nanotubes layer may be obtained by coating the transparent base material with a dispersion containing carbon nanotubes and a solvent and by drying the coating.

While the carbon nanotubes to be used may be any of multi-walled (MW), double-walled (DW) and single-walled (SW) carbon nanotubes as needed, those with a smaller number of layers can be less light-absorptive and achieve a higher transmittance. From this viewpoint, the carbon nanotubes to be used are preferably DW and SW, more preferably SW.

Surface-treated carbon nanotubes may also be employed. Any type of surface treatment such as treatment using a covalent bond (for example, modification with a carboxyl group or the like) and treatment using a non-covalent bond may be used as needed.

The carbon nanotubes may have any aspect ratio. With larger aspect ratios, however, the carbon nanotubes can tend to aggregate so that it can be difficult to disperse them into a liquid. Therefore, and in order to ensure the ability to diffuse into the cured resin layer, the aspect ratio of the carbon nanotubes is preferably from 50 to 5000, more preferably from 100 to 3000. In view of transmittance, the diameter of the carbon nanotubes is preferably 5 nm or less, more preferably 2 nm or less.

The thickness of the deposited carbon nanotubes layer is controlled to 10 nm or less. Cases where the thickness exceeds 10 nm are not preferred in view of transparency. The thickness of the deposited carbon nanotubes layer is preferably 8 nm or less, more preferably 5 nm or less. The deposited carbon nanotubes layer includes at least one deposited layer. The thickness of the deposited carbon nanotubes layer can be controlled by adjusting the concentration of a carbon nanotubes dispersion or the amount of the carbon nanotubes dispersion coating.

Any solvent in which carbon nanotubes can be well dispersed may be used without restriction. Solvents in which the base material is insoluble are preferred, and the solvent may be properly selected depending on the base material. Examples of the solvent may include dimethylformamide, water, isopropyl alcohol, methyl isobutyl ketone, ethanol, methanol, methyl ethyl ketone, and toluene. While carbon nanotubes may be present at any concentration in the carbon nanotubes dispersion, the concentration of carbon nanotubes in the dispersion is generally from 0.001 to 0.3% by weight, preferably from 0.003 to 0.15% by weight. For the purpose of enhancing the dispersibility, a surfactant may be added to the solvent for the carbon nanotubes dispersion. Any surfactant including an anionic, nonionic, cationic, or amphoteric surfactant may be used as needed. The content of the surfactant in the carbon nanotubes dispersion is generally from about 0.01 to about 1% by weight, preferably from 0.05 to 0.5% by weight.

The carbon nanotubes dispersion may be prepared by any method (any carbon nanotubes dispersing method) that can well disperse carbon nanotubes, such as a method with an ultrasonic dispersing device, a homogenizer or the like. When an ultrasonic dispersing device is used, the dispersion time is preferably from 1 minute to 5 hours, more preferably from 10 minutes to 4 hours, still more preferably from 30 minutes to 3 hours.

The deposited carbon nanotubes layer according to the invention may be formed by applying the carbon nanotubes dispersion onto the transparent base material and drying it. Any known coating method such as fountain coating, die coating, spin coating, spray coating, gravure coating, roll coating, and bar coating may be used to apply the carbon nanotubes dispersion onto the transparent base material.

As described above, the thickness of the deposited carbon nanotubes layer may be controlled by controlling the concentration of the carbon nanotubes dispersion or the amount of the carbon nanotubes dispersion coating. At the same time, it is preferred that the open area ratio of the deposited carbon nanotubes layer (an index related to the ratio of the area occupied by the carbon nanotubes to that of the plane of the deposited carbon nanotubes layer) should be controlled to 50% or more. The open area ratio of the deposited carbon nanotubes layer can be controlled by adjusting the concentration of the carbon nanotubes dispersion or the thickness of the carbon nanotubes dispersion coating. In terms of transparency, the deposited carbon nanotubes layer preferably has an open area ratio of 50% or more. The open area ratio is preferably 60% or more, more preferably 70% or more. In terms of ensuring electrical conductivity, the open area ratio is preferably 90% or less, more preferably 80% or less. In order to keep percolation at a higher open area ratio, carbon nanotubes with a relatively high aspect ratio are effectively used.

The deposited carbon nanotubes layer also preferably has a surface resistance of 1.0×10⁹Ω/□ or less, more preferably of 1.0×10⁸Ω/□ or less, still more preferably of 1.0×10⁷Ω/□ or less.

Materials capable of being cured by heat or radiation may be used to form the cured resin layer. Such materials can impart hard coating properties. Examples of such materials include thermosetting resins and radiation-curable resins such as ultraviolet curable resins and electron beam curable resins. In particular, ultraviolet curable resins are preferred, which can efficiently form a cured resin layer by a simple processing operation when cured by ultraviolet radiation. Examples of such curable resins include a variety of resins such as polyester, acrylic, urethane, amide, silicone, epoxy, and melamine resins, including monomers, oligomers, polymers, and the like thereof. In particular, radiation curable resins, specifically ultraviolet curable resins are preferred, because of high processing speed and less thermal damage to the transparent base material. For example, an ultraviolet curable resin having an ultraviolet-polymerizable functional group, particularly having two or more ultraviolet-polymerizable functional groups, specifically including an acrylic monomer or oligomer component with 3 to 6 ultraviolet-polymerizable functional groups is preferably used. The ultraviolet curable resin may be mixed with a photopolymerization initiator.

Examples of the photopolymerization initiator to be used may include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N′,N′-tetramethyl-4,4′-diaminobenzophenone, 1-(4-isopropylphenyl)-2-hydroxy-2-methylpropane-1-one, and other thioxanthone compounds. The photopolymerization initiator may be added in an amount of 0.5 to 5 parts by weight to 100 parts by weight of the material for forming the cured resin layer.

The cured resin layer is formed in such a manner that the total thickness of the deposited carbon nanotubes layer and the cured resin layer is 1.5 μm or more. The total thickness is preferably 2 μm or more, more preferably 5 μm or more, still more preferably 20 μm or more. If the total thickness is less than 1.5 μm, the hard coating properties cannot be ensured. The total thickness is preferably 30 μm or less in view of surface resistance.

Part of the deposited carbon nanotubes layer is diffused in the cured resin layer. The cured resin layer may be formed by a process including the steps of dissolving the material for forming the cured resin layer in a solvent to form a solution, applying the solution onto the deposited carbon nanotubes layer, removing the solvent by drying, and then curing the material. The carbon nanotubes diffuse into the material for forming the cured resin layer, after the solution of the material for forming the cured resin layer is applied onto the deposited carbon nanotubes layer and before the curing of the resin layer is completed. It is believed that the carbon nanotubes should diffuse into the material for forming the cured resin layer in the process of removing the solvent from the solution of the material for forming the cured resin layer by drying.

While the solvent may be of any type, it preferably has a boiling point of 50 to 160° C. in terms of facilitating the diffusion of the carbon nanotubes. More preferably, the solvent has a boiling point of 80 to 130° C. One or more solvents may be used alone or in combination. If two or more solvents are used in the form of a mixture, at least one of the solvents should preferably satisfy the above boiling point condition. If the solvent that is used to dilute the material for forming the cured resin layer has a too low boiling point, the diffusion of the carbon nanotubes can be inhibited. If the boiling point is too high, the amount of the solvent residue can be large. Examples of the solvent include methyl isobutyl ketone, cyclopentanone, ethyl acetate, butyl acetate, and methyl ethyl ketone. In view of the diffusion of the carbon nanotubes, the concentration of the solution is preferably such that the concentration of the solids of the material for forming the cured resin layer can be from about 20 to about 80% by weight, preferably from 30 to 70% by weight.

The surface of the cured resin layer may be formed so as to have an irregular fine structure and thus anti-glare properties. Any appropriate method may be used to form such an irregular fine structure in the surface. An example of such a method includes roughening the surface of the hard coat layer provided on the transparent base material by any appropriate method such as sand blasting, roll embossing, and chemical etching, to form an irregular fine structure. Another example of such a method includes dispersing and adding a spherical or amorphous, inorganic or organic filler into the resin for forming the cured resin layer to form an irregular fine structure. Two or more methods of forming an irregular fine structure may be used in combination to form a layer in which different irregular fine structure surfaces are combined. Examples of the spherical or amorphous, inorganic or organic filler include crosslinked or uncrosslinked organic fine particles of various polymers such as PMMA (poly(methyl methacrylate)), polyurethane, polystyrene, and melamine resins; and electrically-conductive inorganic particles of glass, silica, alumina, calcium oxide, titania, zirconia, cadmium oxide, antimony oxide, or any composite thereof. The filler preferably has an average particle size of 0.5 to 12 μm, more preferably of 1 to 10 μm. The filler is preferably used in an amount of 1 to 50 parts by weight, based on 100 parts by weight of the resin.

Any type of leveling agent may be added to the material for forming the cured resin layer. A fluorochemical or silicone leveling agent may be used as needed. The silicone leveling agent is more preferred. Examples of the silicone leveling agent include polydimethylsiloxane, polyether-modified polydimethylsiloxane, and polymethylalkylsiloxane or the like. Among these silicone leveling agents, reactive silicones are particularly preferred. The addition of a reactive silicone provides surface lubricity and prolonged abrasion resistance. If a siloxane component-containing low refractive index layer is used, the adhesion can be increased using a hydroxyl-containing reactive silicone.

The leveling agent is preferably added in an amount of 5 parts or less by weight, more preferably of 0.01 to 5 parts by weight, based on 100 parts by weight of the total resin component of the material for forming the cured resin layer.

If necessary, a pigment, a filler, a dispersing agent, a plasticizer, an ultraviolet absorbing agent, a surfactant, an antioxidant, a thixotropic agent, or the like may be added to the material for forming the cured resin layer, as long as the performance is not affected. One or more of these additives may be used alone or in any combination.

The cured resin layer may be formed by a process including the steps of coating the deposited carbon nanotubes layer with the material for forming the cured resin layer and drying and curing the material. The method of forming a coating of the composition on the transparent base material may be a known coating method such as fountain coating, die coating, spin coating, spray coating, gravure coating, roll coating, and bar coating.

For example, the energy beam source for use in the radiation curing (particularly ultraviolet curing) may be a high pressure mercury lamp, a halogen lamp, a xenon lamp, a nitrogen laser, an electron beam accelerator, or a radiation source of a radioactive element or the like. In terms of integral exposure dose at a UV wavelength of 365 nm, the exposure dose of the energy beam source is preferably from 50 to 5000 mJ/cm². If the exposure dose is less than 50 mJ/cm², curing can be insufficient so that the hardness of the hard coat layer can be reduced. If the exposure dose is more than 5000 mJ/cm², the hard coat layer can be colored so that the transparency can be reduced.

The transparent electrically-conductive hard-coated substrate produced as described above preferably has a surface resistance of the cured resin layer side of 1.0×10¹⁰Ω/□ or less, more preferably of 1.0×10⁹Ω/□ or less, still more preferably of 1.0×10⁸Ω/□ or less.

An anti-reflection layer may be formed on the cured resin layer. Light incident on an object can undergo a repetition of reflection on the interface, absorption into the inner portion, scattering, or the like and be transmitted to the backside of the object. When an antiglare hard-coated film is attached to an image display, one of the causes of reduction in visibility of images is the reflection of light on the interface between the air and the antiglare hard coat layer. In a method for reducing the surface reflection, a thin film having strictly controlled thickness and refractive index is laminated on the surface of the antiglare hard coat layer such that an anti-reflection function is produced by canceling out mutually opposite phases of incident light and reflected light based on the optical interference effect.

For the purpose of reducing the refractive index, hollow spherical silicon oxide ultrafine particles may be added to the anti-reflection film. The hollow spherical silicon oxide ultrafine particles may be characterized by having an average particle size of 5 nm to 300 nm, having a hollow spherical structure comprising an outer shell with pores and a hollow formed inside the outer shell, and containing, in the hollow, a solvent and/or a gas provided in the process of preparing the ultrafine particles. It is preferred that the precursor material for forming the hollow should remain in the hollow. The outer shell preferably has a thickness in the range of 1 nm to 50 nm and in the range of 1/50 to ⅕ of the average particle size. The outer shell preferably comprises a plurality of coating layers. It is preferred that the pores should be blocked so that the hollow should be sealed with the outer shell. Such particles are preferably used, because the porous or hollow structure is retained in the anti-reflection layer and thus can reduce the refractive index of the anti-reflection layer. For example, such hollow spherical silicon oxide ultrafine particles may be produced preferably using the silica fine particle production method disclosed in JP-A No. 2000-233611.

In order to improve the film strength, an inorganic sol may be added to the low-refractive-index layer (anti-reflection layer). While any sol such as a silica, alumina, or magnesium fluoride sol may be used, a silica sol is particularly preferred. The amount of addition of the inorganic sol is appropriately set within the range of 80 to 100 parts by weight, based on 100 parts by weight of the total solid of the material for forming the low-refractive-index layer. The inorganic sol preferably has a particle size in the range of 2 to 50 nm, more preferably of 5 to 30 nm.

The anti-reflection layer is often attached to the outermost surface of an image display and thus can easily become soiled by the external environment. Particularly, in familiar cases, such contaminants as fingerprints or finger marks, sweat and hair dressings can easily adhere so that the surface reflectance can be changed or the adhering contaminants can look white and stand out to make the displayed content unclear, and thus the contamination can easily stand out as compared with the case where a simple transparent plate or the like is used. In this case, in order to provide a function for preventing contaminants from adhering or for removing contaminants easily, a fluorine group-containing silane compound, a fluorine group-containing organic compound or the like may be layered on the anti-reflection layer.

The transparent base material or the cured resin layer formed by coating the transparent base material may be subjected to any of various surface treatments so that adhesion can be increased between the transparent base material and the cured resin layer (hard coat layer), between the transparent base material and the polarizer or between the cured resin layer and the anti-reflection layer. The surface treatment to be used may be low-pressure plasma treatment, ultraviolet radiation treatment, corona treatment, flame treatment, or acid or alkali treatment. When triacetyl cellulose is used as the transparent base material, alkali saponification treatment is preferably used as the surface treatment. Such treatment is more specifically described below. As to the saponification treatment, the surface of the cellulose ester film immersing in an alkali solution then washing it with water and drying a in cycle process is preferably performed. The alkali solution may be a potassium hydroxide solution or a sodium hydroxide solution, in which the normal concentration of the hydroxide ion is preferably from 0.1 N to 3.0 N, more preferably from 0.5 N to 2.0 N. The alkali solution preferably has a temperature in the range of 25° C. to 90° C., more preferably of 40° C. to 70° C. Thereafter, washing with water and drying are performed so that surface-treated triacetyl cellulose is obtained.

The transparent electrically-conductive hard-coated substrate of the invention and a polarizer or a polarizing plate may be laminated with an adhesive, a pressure-sensitive adhesive or the like to form a polarizing plate having the function according to the invention. Polarizing plates are generally placed on both sides of a liquid crystal cell. Polarizing plates are generally arranged in such a manner that the absorption axes of the two polarizing plates is substantially perpendicular to each other. The polarizing plate to be used generally includes a polarizer and a transparent protective film(s) provided on one or both sides of the polarizer. When transparent protective films are provided on both sides of a polarizer, the front and rear transparent proactive films may be made of the same material or different materials.

The polarizer may be any of various types of polarizers. Examples of the polarizer include a film produced by adsorbing a dichroic material such as iodine or a dichroic dye onto a hydrophilic polymer film, such as a polyvinyl alcohol film, a partially formalized polyvinyl alcohol film, a partially saponified film of an ethylene-vinyl acetate copolymer and by uniaxially stretching the film, and an oriented polyene film such as a product obtained by dehydration of a polyvinyl alcohol film and a product obtained by dehydrochlorination of a poly(vinyl chloride) film. In particular, a polarizer comprising a polyvinyl alcohol film and a dichroic material such as iodine has a high polarization dichroic ratio and thus is preferred. The thickness of these polarizers is generally, but not limited to, from 5 to 80 μm.

For example, an iodine-dyed, uniaxially-stretched, polyvinyl alcohol film polarizer may be prepared by a process including the steps of immersing a polyvinyl alcohol film in an aqueous iodine solution to dye it and stretching the film to 3 to 7 times the original length. If necessary, the film may also be immersed in an aqueous solution of potassium iodide or the like, which may contain boric acid, zinc sulfate, zinc chloride, or the like. If necessary, the polyvinyl alcohol film may be washed with water by immersing it in water before dyeing.

If the polyvinyl alcohol film is washed with water, dirt or any anti-blocking agent can be cleaned from the surface of the polyvinyl alcohol film, and the polyvinyl alcohol film can also be allowed to swell so that unevenness such as uneven dyeing can be effectively prevented. Stretching may be performed after dyeing with iodine or while dyeing or may be followed by dyeing with iodine. Stretching may also be performed in an aqueous solution of boric acid, potassium iodide or the like or in a water bath.

As described above, the transparent electrically-conductive hard-coated substrate of the invention may be attached to one side of a polarizer, or alternatively a polarizer itself may be used as the transparent base material to form the transparent electrically-conductive hard-coated substrate of the invention. Besides these modes, the transparent electrically-conductive hard-coated substrate of the invention may also be attached onto a transparent protective film of a polarizing plate, which includes a polarizer and transparent protective films provided on both sides of the polarizer.

The transparent protective film preferably has high transparency, mechanical strength, thermal stability, water-blocking ability, retardation stability, or the like. Examples of the material for forming the transparent protective film include those described for the transparent base material. The transparent protective film may also be formed as a cured layer of a thermosetting or ultraviolet curable resin, such as an acrylic, urethane, acrylic urethane, epoxy, or silicone resin.

In terms of polarization properties, durability or the like, cellulose resins such as triacetyl cellulose and norbornene resins are preferably used for the transparent protective film. Examples thereof include Fujitac (trade name) series manufactured by Fuji Photo Film Co., Ltd., Zeonor (trade name) series manufactured by Nippon Zeon Co., Ltd. and Arton (trade name) series manufactured by JSR Corporation.

While the thickness of the transparent protective film may be determined as needed, it is generally from about 1 to about 500 μm, more preferably from 5 to 200 μm, particularly preferably from 10 to 150 μm, in view of workability such as strength and handleability or thin layer properties or the like. In the above range, the transparent protective film can mechanically protect a polarizer; prevent the polarizer from shrinking even under exposure to high temperatures or high humidity, or keep stable optical properties.

The transparent protective film to be used should preferably have an optimized retardation value, because the retardation values in the film plane and in the thickness direction can influence the viewing angle properties of liquid crystal displays. It should also be noted that the transparent protective film whose retardation value should be optimized is that laminated on the surface of a polarizer close to a liquid crystal cell and that another transparent protective film laminated on the surface of another polarizer distant from the liquid crystal cell does not alter the optical properties of the liquid crystal display and thus does not need to have an optimized retardation value.

The transparent protective film laminated on the surface of the polarizer close to the liquid crystal cell preferably has an in-plane retardation (Re) of 0 to 5 nm, more preferably of 0 to 3 nm, still more preferably of 0 to 1 nm and preferably has a thickness-direction retardation (Rth) of 0 to 15 nm, more preferably of 0 to 12 nm, still more preferably of 0 to 10 nm, particularly preferably of 0 to 5 nm, most preferably of 0 to 3 nm.

The transparent protective film and the polarizer may be laminated by any method. For example, they may be laminated through an adhesive comprising an acrylic polymer or a vinyl alcohol polymer, further the vinyl alcohol polymer adhesive can comprising at least a water-soluble crosslinking agent for, such as boric acid or borax or glutaraldehyde, melamine or oxalic acid, or any other adhesive. This method can provide a product that resists peeling under the influence of humidity or heat and has good light transmittance or polarization degree. The adhesive to be used is preferably a polyvinyl alcohol adhesive, because it has good adhesiveness to polyvinyl alcohol, a material for the polarizer.

A polymer film containing the norbornene resin may be used as the transparent protective film to be laminated on the polarizer. In such a case, a pressure-sensitive adhesive may be used, which preferably has high transparency and low birefringence and can preferably exhibit a sufficient adhesive strength even when used in the form of a thin layer. For example, such a pressure-sensitive adhesive may be a dry lamination adhesive using a polyurethane resin solution and a polyisocyanate resin solution to be mixed with each other, a styrene-butadiene rubber adhesive, or a two-component curable epoxy adhesive such as an adhesive comprising the two components, an epoxy resin and polythiol, or an adhesive comprising the two components, an epoxy resin and polyamide. In particular, a solvent type adhesive, specifically a two-component curable epoxy adhesive is preferred, and a transparent adhesive is preferred. The adhesive strength of some adhesives can be increased using an appropriate adhesive undercoating agent. When such adhesives are used, an adhesive undercoating agent is preferably used.

The adhesive undercoating agent is not limited to any particular agent, as long as it can form an adhesiveness-enhancing layer. Examples of available adhesive undercoating agents include so-called coupling agents such as a silane coupling agent having a reactive functional group such as an amino, vinyl, epoxy, mercapto, or chloro group, and a hydrolyzable alkoxysilyl group in the same molecule, a titanate coupling agent having a titanium-containing, hydrolyzable, hydrophilic group and an organic functional group in the same molecule, and an aluminate coupling agent having a aluminum-containing, hydrolyzable, hydrophilic group and an organic functional group in the same molecule; and a resin having a reactive organic group, such as an epoxy resin, an isocyanate resin, an urethane resin, and an ester urethane resin. In particular, a silane coupling agent-containing layer is preferred, because it is easy to handle industrially.

The polarizing plate preferably has an adhesive layer or a pressure-sensitive adhesive layer on one or both sides so as to be easily laminated to a liquid crystal cell.

The adhesive or the pressure-sensitive adhesive is not limited to any particular adhesive and may be properly selected, for example, from adhesives based on polymers such as acrylic polymers, silicone polymers, polyester, polyurethane, polyamide, polyvinyl ether, vinyl acetate/vinyl chloride copolymers, modified polyolefins, epoxy polymers, fluoropolymers, and rubbers such as natural rubbers and synthetic rubbers. In particular, acrylic pressure-sensitive adhesives are preferably used, because they have good optical transparency and good weather or heat resistance and exhibit suitable wettability and adhesion properties such as cohesiveness and adhesiveness.

Other optical components for use in combination with the polarizing plate of the invention are described in the following. Examples of other optical components include, but are not limited to, a reflective or transflective polarizing plate that is a laminate of an elliptically or circularly polarizing plate and a reflecting plate or a transflective plate. A reflective or transflective elliptically polarizing plate may also be used, which comprises a combination of the reflective or transflective polarizing plate and a retardation plate. When used for transmissive or transflective liquid crystal displays, the transparent electrically-conductive hard-coated substrate or polarizing plate of the invention may be used in combination with a commercially available brightness enhancement film (a polarized light separating film having a polarization selective layer, such as D-BEF manufactured by Sumitomo 3M Limited) to form a display with high display performance.

The transparent electrically-conductive hard-coated substrate, the polarizing plate, or the like may be formed by sequentially and independently laminating the components in the process of manufacturing a liquid crystal display. It is preferred, however, that the lamination should be performed in advance so that quality stability, lamination workability or the like can be high and that the efficiency of manufacturing a liquid crystal display or the like can be increased.

### EXAMPLES

Examples of the invention and Comparative Examples are described below, which are not intended to limit the scope of the invention. The physical properties of the transparent electrically-conductive hard-coated substrate according to the invention were evaluated by the methods described below. The results are shown in Table 1.

### (Surface Resistance of Deposited Carbon Nanotubes Layer)

The surface resistance was measured with Hiresta MCP-HT450 manufactured by Dia Instruments Co., Ltd.

### (Open Area Ratio of Deposited Carbon Nanotubes Layer)

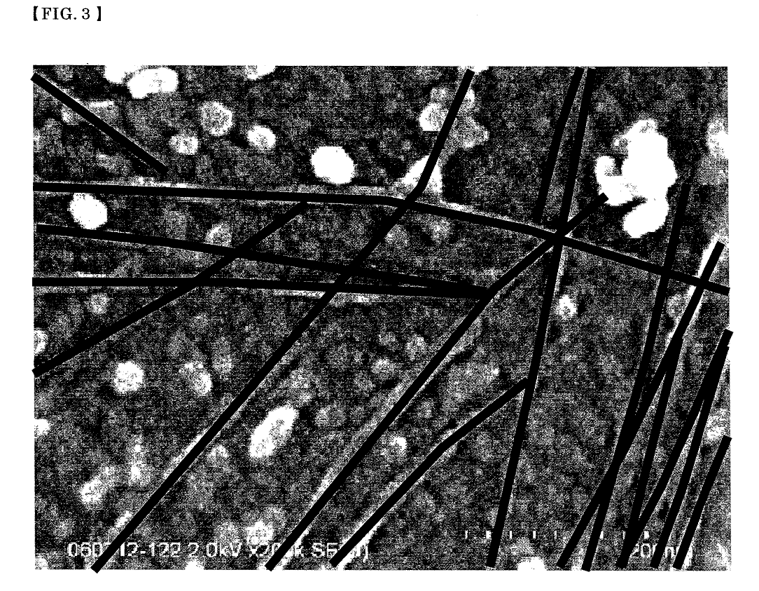

The open area ratio of the deposited carbon nanotubes layer was calculated by subtracting, from 100%, the ratio (%) of the area occupied by the carbon nanotubes to that of the plane of the deposited carbon nanotubes layer. The calculation process included the steps of applying the carbon nanotubes dispersion of each example onto a polyethylene terephthalate film, drying it to form a deposited carbon nanotubes layer, and estimating the area ratio of the carbon nanotubes per unit area from an SEM image of the layer to determine the open area ratio. The measurement was repeated five times, and the average was calculated. FIG. 3 shows an SEM image in a case where the measurement was performed using a dispersion for Example 2. In Example 2, the average value of the ratio of the area occupied by carbon nanotubes was 22.5%, and thus the open area ratio was 77.5%.

### (Surface Resistance of the Cured Resin Layer Side of Transparent Electrically-Conductive Hard-Coated Substrate)

The surface resistance of the optical product with coated carbon nanotubes was measured with a resistivity meter (Hiresta MCP-HT450 manufactured by Dia Instruments Co., Ltd.). In Example 2, the surface resistance was 8.22×10⁵Ω/□.

### (Reduction in Transmittance)

The transparent base material itself and the deposited carbon nanotubes layer-formed transparent base material were each measured for transmittance using Hazemeter HM-150 manufactured by Murakami Color Research Laboratory Co., Ltd. A reduction in transmittance, which was due to the formation of the deposited carbon nanotubes layer, was determined from the difference between the measured transmittances.

### (Abrasion Resistance)

Steel wool #1000 was uniformly attached to a smooth section of a cylinder 25 mm in diameter. The attached steel wool was reciprocated 30 times on the surface of a sample at a speed of about 100 mm per second under a load of 1.5 kg, and then evaluations were visually made according to the following criteria:

O: There is no flaw.
Δ: There are small flaws but is no influence on visibility.
x: There are significant flaws degrading visibility.

### Example 1

### (Formation of Deposited Carbon Nanotubes Layer)

A mixture of 0.1 parts by weight of SW carbon nanotubes (Aldrich 652490, modified with carboxyl groups) and 100 parts by weight of dimethylformamide (DMF) was prepared and treated for 3 hours using a sonicator (an ultrasonic dispersing machine manufactured by Fischer Instruments K.K.) to form a carbon nanotubes dispersion. The dispersion was applied onto a glass substrate (1.1 mm in thickness) with a spin coater (1000 rpm×100 s) and dried at 100° C. for 2 minutes so that the solvent was removed and the carbon nanotubes were deposited with a thickness of 10 nm or less on the film. The surface resistance of the deposited carbon nanotubes layer is shown in Table 1.

### (Formation of Cured Resin Layer)

A material solution for forming the cured resin layer was prepared by mixing 100 parts by weight of Unidec 17-806 (a urethane acrylic resin, manufactured by Dainippon Ink and Chemicals, Incorporated, 80 parts by weight of solids and 20 parts by weight of butyl acetate (boiling point: 126° C.)), 2.4 parts by weight of Irgacure 184 (a photopolymerization initiator, manufactured by Ciba Specialty Chemicals), and 100 parts by weight of methyl isobutyl ketone (boiling point: 116.2° C.). The solution was applied onto the deposited carbon nanotubes layer with a spin coater (2000 rpm×20 s), dried at 100° C. for 2 minutes and then cured by UV radiation so that a cured resin layer was formed in such a manner that the total thickness of the deposited carbon nanotubes layer and the cured resin layer reached 2 μm, and thus a transparent electrically-conductive hard-coated substrate was obtained. Table 1 also shows the surface resistance of the cured resin layer side of the resulting transparent electrically-conductive hard-coated substrate, the resistance in its thickness direction, a reduction in transmittance, and the abrasion resistance thereof.

### Examples 2 to 17

Transparent electrically-conductive hard-coated substrates were prepared using the process of Example 1 including the steps of forming a deposited carbon nanotubes layer and then forming a cured resin layer on the deposited carbon nanotubes layer, except that the type of the transparent substrate, the type of the carbon nanotubes, the concentration of the dispersion thereof, the type of the solvent, the addition of a surfactant to the dispersion, the material for forming the cured resin layer, the type of the solvent, or the thickness thereof was changed as shown in Table 1. The physical properties and other properties of the resulting transparent electrically-conductive hard-coated substrates are shown in Table 1.

### Comparative Example 1

A mixture of 0.15 parts by weight of SW carbon nanotubes (Aldrich 652490, modified with carboxyl groups) and 100 parts by weight of DMF was prepared and treated for 3 hours using a sonicator (an ultrasonic dispersing machine) to form a carbon nanotubes dispersion. The dispersion and Cycloaliphatic (an epoxy resin, manufactured by Nitto Denko Corporation) were mixed in such a manner that 0.1 parts by weight of the carbon nanotubes were mixed with 100 parts by weight of the epoxy resin, so that a solution was obtained. The solution was applied onto a glass substrate with a spin coater (1000 rpm×100 s) and dried at 150° C. for 3 hours to form a 1 μm-thick cured resin layer, so that a transparent electrically-conductive hard-coated substrate was obtained. The physical properties and other properties of the resulting transparent electrically-conductive hard-coated substrate are shown in Table 1.

### Comparative Examples 2 and 3

Transparent electrically-conductive hard-coated substrates were obtained using the process of Comparative Example 1, except that the concentration of the carbon nanotubes in the dispersion was changed as shown in Table 1. The physical properties and other properties of the resulting transparent electrically-conductive hard-coated substrates are shown in Table 1.

### Comparative Example 4

A transparent electrically-conductive hard-coated substrate was obtained by forming a cured resin layer on an ITO film (10 nm in thickness) provided on a glass substrate (1.1 mm in thickness) in a similar way to Example 1. The physical properties and other properties of the resulting transparent electrically-conductive hard-coated substrate are shown in Table 1.

### Comparative Example 5

A transparent electrically-conductive hard-coated substrate was prepared using the process of Example 2, except that the total thickness obtained after the formation of the cured resin layer was 1 μm. The physical properties and other properties of the resulting transparent electrically-conductive hard-coated substrate are shown in Table 1.

### Comparative Example 6

A mixture of 0.15 parts by weight of SW carbon nanotubes (Aldrich 652490, modified with carboxyl groups) and 100 parts by weight of DMF was prepared and treated for 3 hours using a sonicator (an ultrasonic dispersing machine) to form a carbon nanotubes dispersion. The dispersion and Cycloaliphatic (an epoxy resin, manufactured by Nitto Denko Corporation) were mixed in such a manner that 1 part by weight of the carbon nanotubes were mixed with 1 part by weight of the epoxy resin, so that a solution was obtained. The solution was applied onto a glass substrate with a spin coater (1000 rpm×100 s) and dried at 150° C. for 3 hours to form a 10 nm-thick cured film.

A mixture of 0.15 parts by weight of SW carbon nanotubes (Aldrich 652490, modified with carboxyl groups) and 100 parts by weight of DMF was further prepared and treated for 3 hours using a sonicator (an ultrasonic dispersing machine) to form a carbon nanotubes dispersion. The dispersion and Cycloaliphatic (an epoxy resin, manufactured by Nitto Denko Corporation) were mixed in such a manner that 0.1 parts by weight of the carbon nanotubes were mixed with 100 parts by weight of the epoxy resin, so that a solution was obtained. The solution was applied onto the resulting film with a spin coater (2000 rpm×20 s) and dried at 150° C. for 3 hours to form a 2 μm-thick cured firm, so that a transparent electrically-conductive hard-coated substrate was obtained. The physical properties and other properties of the resulting transparent electrically-conductive hard-coated substrate are shown in Table 1.

TABLE 1

| | | CNT Dispersion | | | | |
|---|---|---|---|---|---|---|
| | Base | | Dispersion | CNT Dispersion | | Surfactant |
| | Material | CNT Type | Solvent | Concentration | Surfactant Type | Concentration |
| Example 1 | Glass | SWCNT-COOH (Aldrich) | DMF | 0.1 wt % | — | — |
| Example 2 | Glass | SWCNT-COOH (Aldrich) | DMF | 0.15 wt % | — | — |
| Example 3 | Glass | SWCNT-COOH (Aldrich) | DMF | 0.2 wt % | — | — |
| Example 4 | Glass | COOH (Cheap-tubes) | DMF | 0.1 wt % | — | — |
| Example 5 | Glass | COOH (Cheap-tubes) | DMF | 0.15 wt % | — | — |
| Example 6 | Glass | SWCNT-COOH (Aldrich) | IPA | 0.06 wt % | — | — |
| Example 7 | Glass | SWCNT-COOH (Aldrich) | IPA | 0.08 wt % | — | — |
| Example 8 | Glass | SWCNT-COOH (Aldrich) | IPA | 0.10 wt % | — | — |
| Example 9 | Glass | SWCNT (Cheap tube) | Water | 0.09 wt % | sodium | 0.1 wt % |
| | | | | | Taurodeoxycholate | |
| Example 10 | Glass | SWCNT (Cheap tube) | Water | 0.12 wt % | sodium | 0.1 wt % |
| | | | | | Taurodeoxycholate | |
| Example 11 | Glass | SWCNT (Cheap tube) | Water | 0.15 wt % | sodium | 0.1 wt % |
| | | | | | Taurodeoxycholate | |
| Example 12 | TAC | SWCNT-COOH (Cheap tube) | Water:IPA = 3:1 | 0.9 wt % | sodium | 0.1 wt % |
| | | | | | Dodecylbenezene- | |
| | | | | | sulfonate | |
| Example 13 | TAC | SWCNT-COOH (Cheap tube) | Water:IPA = 3:1 | 0.10 wt % | sodium | 0.1 wt % |
| | | | | | Dodecylbenezene- | |
| | | | | | sulfonate | |
| Example 14 | Glass | SWCNT-COOH (Aldrich) | DMF | 0.15 wt % | — | — |
| Example 15 | Glass | SWCNT-COOH (Aldrich) | DMF | 0.15 wt % | — | — |
| Example 16 | Glass | SWCNT-COOH (Aldrich) | DMF | 0.15 wt % | — | — |
| Example 17 | Glass | SWCNT-COOH (Aldrich) | MIBK | 0.1 wt % | — | — |
| Comparative | Glass | SWCNT-COOH (Aldrich) | DMF | Direct: 0.1 wt % | — | — |
| Example 1 | | | | | | |
| Comparative | Glass | SWCNT-COOH (Aldrich) | DMF | Direct: 0.4 wt % | — | — |
| Example 2 | | | | | | |
| Comparative | Glass | SWCNT-COOH (Aldrich) | DMF | Direct: 1 wt % | — | — |
| Example 3 | | | | | | |
| Comparative | ITO Glass | — | — | — | — | — |
| Example 4 | | | | | | |
| Comparative | Glass | SWCNT-COOH (Aldrich) | DMF | 0.15 wt % | — | — |
| Example 5 | | | | | | |
| Comparative | Glass | SWCNT-COOH (Aldrich) | DMF | 0.15 wt % | — | — |
| Example 6 | | | | | | |

| | Deposited | | | | Transparent Electrically-Conductive Hard-Coated | | |
|---|---|---|---|---|---|---|---|
| | CNT Layer | Cured Resin Layer | | | Substrate | | |
| | Thickness | | | Total | Surface Resistance | Transmittance | Abrasion |
| | (nm) | Material | Solvent | Thickness | (Ω/□) | Reduction (Δ% T) | Resistance |
| Example 1 | 10> | Acrylic HC | Butyl Acetate + MIBK | 2 μm | 2.82E+07 | 1.05 | ◯ |
| Example 2 | 10> | Acrylic HC | Butyl Acetate + MIBK | 2 μm | 4.55E+06 | 2.03 | ◯ |
| Example 3 | 10> | Acrylic HC | Butyl Acetate + MIBK | 2 μm | 4.55E+06 | 5.52 | ◯ |
| Example 4 | 10> | Acrylic HC | Butyl Acetate + MIBK | 2 μm | 6.04E+07 | 4.47 | ◯ |
| Example 5 | 10> | Acrylic HC | Butyl Acetate + MIBK | 2 μm | 9.52E+05 | 8.30 | ◯ |
| Example 6 | 10> | Acrylic HC | Butyl Acetate + MIBK | 2 μm | 7.20E+08 | 1.10 | ◯ |
| Example 7 | 10> | Acrylic HC | Butyl Acetate + MIBK | 2 μm | 4.62E+07 | 1.63 | ◯ |
| Example 8 | 10> | Acrylic HC | Butyl Acetate + MIBK | 2 μm | 5.55E+06 | 2.50 | ◯ |
| Example 9 | 10> | Acrylic HC | Butyl Acetate + MIBK | 2 μm | 9.50E+07 | 0.64 | ◯ |
| Example 10 | 10> | Acrylic HC | Butyl Acetate + MIBK | 2 μm | 5.00E+06 | 1.01 | ◯ |
| Example 11 | 10> | Acrylic HC | Butyl Acetate + MIBK | 2 μm | 8.53E+05 | 3.27 | ◯ |
| Example 12 | 10> | Acrylic HC | Butyl Acetate + MIBK | 2 μm | 6.40E+08 | 1.40 | ◯ |
| Example 13 | 10> | Acrylic HC | Butyl Acetate + MIBK | 2 μm | 5.20E+09 | 1.70 | ◯ |
| Example 14 | 10> | Acrylic HC | Butyl Acetate + MIBK | 7.6 μm | 1.61E+07 | 1.95 | ◯ |
| Example 15 | 10> | Acrylic HC | Butyl Acetate + MIBK | 10.4 μm | 1.37E+07 | 2.05 | ◯ |
| Example 16 | 10> | Acrylic HC | Butyl Acetate + MIBK | 16.5 μm | 1.34E+07 | 1.98 | ◯ |
| Example 17 | 10> | AG | Ethyl Acetate | 8 μm | 9.53E+07 | 2.06 | ◯ |
| Comparative | — | Epoxy | — | 1 μm | 1.64E+13 | 2.90 | X |
| Example 1 | | | | | | | |
| Comparative | — | Epoxy | — | 1 μm | 1.06E+13 | 3.00 | X |
| Example 2 | | | | | | | |
| Comparative | — | Epoxy | — | 5 μm | 6.98E+10 | opaque | Δ |
| Example 3 | | | | | | | |
| Comparative | — | Acrylic HC | Butyl Acetate + MIBK | 2 μm | Over | — | ◯ |
| Example 4 | | | | | | | |
| Comparative | 10> | Acrylic HC | Butyl Acetate + MIBK | 1 μm | 4.35E+06 | 2.03 | X |
| Example 5 | | | | | | | |
| Comparative | 10> | Epoxy | DMF | 2 μm | 1.56E+11 | 3.20 | Δ |
| Example 6 | | | | | | | |

Table 1 uses the following abbreviations:

TAC: triacetyl cellulose (80 μm in thickness);
DMF: dimethylformamide
IPA: isopropyl alcohol (In Examples 12 and 13, the blend ratio to water is by weight);
MIBK: methyl isobutyl ketone;
SWCNT-COOH (Aldrich): SW carbon nanotubes (Aldrich 652490, modified with carboxyl groups, 5 nm in diameter, 100 to 1000 in aspect ratio);
COOH (Cheap Tubes): MW carbon nanotubes (Cheap Tubes Inc., MWNT-COOH, with a diameter of less than 8 nm, 100 to 1000 in aspect ratio);
SWNT (Cheap Tubes): SW carbon nanotubes (Cheap Tubes Inc., SWNT 90% by weight, with a diameter of less than 5 nm, 1000 to 30000 in aspect ratio);
Acrylic HC: 100 parts by weight of Unidec 17-806 (a urethane acrylic resin, manufactured by Dainippon Ink and Chemicals, Incorporated, 80 parts by weight of solids and 20 parts by weight of butyl acetate (boiling point: 126° C.)); and
Epoxy: Cycloaliphatic (an epoxy resin, manufactured by Nitto Denko Corporation).

In Example 17, AG was used, which was prepared by mixing 100 parts by weight of Grandic PC4-1097 (a urethane acrylic resin, manufactured by Dainippon Ink and Chemicals, Incorporated), 0.13 parts by weight of Megafac F479 (a leveling agent, manufactured by Dainippon Ink and Chemicals, Incorporated), 30 parts by weight of ethyl acetate, and SSX-108TNL (manufactured by Sekisui Plastics Co., Ltd., 13.2 parts of PMMA-polystyrene copolymer particles) and was a material solution for forming the cured resin layer and capable of forming an irregular fine structure.

As shown in Table 1, the cured resin layer side of each transparent electrically-conductive hard-coated substrate has a surface resistance of 1.0×10¹⁰Ω/□ or less and thus possesses electrical conductivity, even though the cured resin layer, an insulator, is formed on the electrically-conductive carbon nanotubes layer. In each transparent electrically-conductive hard-coated substrate, the reduction in transmittance is small, the abrasion resistance is high, and transparency and hard coating properties are retained.

In contrast, Comparative Examples 1 to 3 are each a case where carbon nanotubes are directly dispersed in the material for forming the cured resin layer. In Comparative Example 1 or 2, the carbon nanotubes content is so low that the surface resistance is high and the in-plane electrical conductivity is insufficient. In Comparative Example 3, the carbon nanotubes content is relatively high so that the surface resistance is reduced to some extent, but the in-plane electrical conductivity is still insufficient, and the transparency is poor due to the high carbon nanotubes content. It should be noted that in each example according to the invention, the effect as described above is produced with a carbon nanotubes content lower than that in Comparative Example 1.

Comparative Example 4 is an example using ITO for an electrically-conductive film and shown for reference. In Comparative Example 5, the total thickness with respect to the cured resin layer is small, the abrasion resistance is poor, and the hard coating properties are not satisfactory.

In Comparative Example 6, a layer corresponding to the deposited carbon nanotubes layer according to the invention is formed by fixing carbon nanotubes with an epoxy resin, and then a layer corresponding to the cured resin layer according to the invention is formed using an epoxy resin to which a small amount of carbon nanotubes has been added in advance. The composition of each layer seems to be almost the same between the invention and Comparative Example 6. However, the invention and Comparative Example 6 are different in that in the invention, the carbon nanotubes derived from the deposited carbon nanotubes layer is diffused in the cured resin layer, while in Comparative Example 6, the carbon nanotubes have been dispersed in advance. It has been found that according to the invention, the resistance, particularly the resistance in the thickness direction can be low due to the difference.

What is claimed is:

1. A transparent electrically-conductive hard-coated substrate, comprising:
a transparent base material;
a deposited carbon nanotubes layer formed on the transparent base material; and
a cured resin layer formed on the deposited carbon nanotubes layer, wherein
the deposited carbon nanotubes layer has a thickness of 10 nm or less,
the total thickness of the deposited carbon nanotubes layer and the cured resin layer is 1.5 μm or more, and
part of the deposited carbon nanotubes layer is diffused into the cured resin layer so that carbon nanotubes are present in the cured resin layer.

2. The transparent electrically-conductive hard-coated substrate according to claim 1, wherein the carbon nanotubes is a single-walled carbon nanotubes.

3. The transparent electrically-conductive hard-coated substrate according to claim 1, wherein a cured resin layer side of the transparent electrically-conductive hard-coated substrate has a surface resistance of 1.0×10¹⁰Ω/□ or less.

4. The transparent electrically-conductive hard-coated substrate according to claim 1, wherein the total thickness of the deposited carbon nanotubes layer and the cured resin layer is from 1.5 μm to 30 μm.

5. The transparent electrically-conductive hard-coated substrate according to claim 1, wherein an outer side of the cured resin layer has an irregular fine surface structure.

6. The transparent electrically-conductive hard-coated substrate according to claim 1, further comprising at least one anti-reflection layer formed on the cured resin layer.

7. A polarizing plate, comprising:
a polarizer; and
the transparent electrically-conductive hard-coated substrate according to claim 1, wherein the transparent base material side of the substrate is laminated with at least one side of the polarizer.

8. An image display, comprising the transparent electrically-conductive hard-coated substrate according to claim 1 or the polarizing plate according to claim 7.

9. A method for producing a transparent electrically-conductive hard-coated substrate that comprises a transparent base material, a deposited carbon nanotubes layer on the transparent base material and a cured resin layer on the deposited carbon nanotubes layer, comprising the steps of:
applying, to a transparent base material, a carbon nanotubes dispersion containing carbon nanotubes and a solvent and drying it to form a deposited carbon nanotubes layer with a thickness of 10 nm or less;
applying, to the deposited carbon nanotubes layer, a solution of a material for forming a cured resin layer in a solvent, removing the solvent by drying, then curing the material to form a cured resin layer such that the deposited carbon nanotubes layer and the cured resin layer provide a total thickness of 1.5 μm or more, and
allowing carbon nanotubes to diffuse from part of the deposited carbon nanotubes layer to the material for forming the cured resin layer before the curing for the cured resin layer is completed.

10. The method according to claim 9, wherein the deposited carbon nanotubes layer has a surface resistance of 1.0×10⁹Ω/□ or less.

11. The method according to claim 9, wherein the deposited carbon nanotubes layer has an open area ratio of 50% or more.

12. The method according to claim 9, wherein the solvent used in the solution of the material for forming the cured resin layer has a boiling point of 50° C. to 160° C.

13. The method according to claim 9, wherein the carbon nanotubes is a single-walled carbon nanotubes.

14. The method according to claim 9, wherein a cured resin layer side of the obtained transparent electrically-conductive hard-coated substrate has a surface resistance of 1.0×10¹⁰Ω/□ or less.

15. The method according to claim 9, wherein the total thickness of the deposited carbon nanotubes layer and the cured resin layer is from 1.5 μm to 30 μm.
